(19) United States
(12) Patent Application Publication
(10) Pub. No.: US 2014/0308422 A1
(43) Pub. Date: Oct. 16, 2014

(54) LIQUID COMPOSITE HIGH-INTENSITY SWEETENER AND PREPARATION METHOD THEREOF

(71) Applicant: Techno (Fujian) Food Ingredients Co., Ltd., Yongan (CN)

(72) Inventors: Ziang CHEN, Yongan (CN); Jianheng LI, Yongan (CN); Can CUI, Yongan (CN); Juemin SHE, Yongan (CN); Huirong SU, Yongan (CN)

(73) Assignee: Techno (Fujian) Food Ingredients Co., Ltd., Yongan (CN)

(21) Appl. No.: 14/220,004

(22) Filed: Mar. 19, 2014

(30) Foreign Application Priority Data
Apr. 11, 2013 (CN) 201310124930.3

(51) Int. Cl. A23L 1/236

(52) U.S. Cl. CPC A23L 1/2364; A23L 1/2363
USPC 426/548

(57) ABSTRACT

A liquid composite high-intensity sweetener, comprises a sweet substance and a solvent, wherein the sweet substance is one or combination of a plurality of the following components: aspartame, sucralose, acesulfame and neotame; and the solvent comprises water and one or combination of a plurality of the following components: ethanol, propylene glycol, phosphoric acid, citric acid, lactic acid, acetic acid, malic acid, ascorbic acid, glucose acid, tartaric acid, acetate, lactate, citrate, phosphate, sorbic acid, sorbate, benzoic acid and benzoate. In addition, the present invention further claims a method for preparing the liquid composite high-intensity sweetener. The liquid composite high-intensity sweetener not only has sweet taste similar to sucrose and good quality, but also is mixed uniformly without particles remained; the actual requirements of production and consumption are well met.

### TECHNICAL FIELD OF THE INVENTION

The present invention relates to technical field of food additives, specifically to a liquid composite high-intensity sweetener and preparation method thereof.

### BACKGROUND OF THE INVENTION

Currently, the sweetener used as food sdditives can be divided into two types: nutritional type and non-nutritional type. The nutritional sweetener includes sucrose, glucose, fructose, isomerized sugar, maltose and sorbose, and polyhydric alcohols like xylitol, sorbitol, mannitol, lactitol and erythritol. The non-nutritional sweetener is sweetener of high sweetness, including natural substances like stevioside, glycyrrhizin, mogrosides, flavonoid glucosides and Thaumatin, as well as chemosynthetic substances like saccharin, sodium cyclamate, aspartame (APM), Acesulfame (AK sugar), sucralose and neotame. Compared with the nutritional sweetener, the non-nutritional sweetener does not generate heat or generates very little heat, and is not easy to be digested and assimilated, so it generally does not cause rise of blood sugar and blood lipid. The non-nutritional sweetener is suitable for both common people and the obese patients and diabetic patients. Therefore, it is widely applied in food field as a safe and healthy food material.

However, the consumers are used to the natural sweet taste of the traditionally used sugar, while most of the non-nutritional high-intensity sweeteners have problems that after consuming people may feel bitterness and astringency in the mouth, and also sweetness is too high to be used, so the consumers are not satisfied with the sweetness quality of these non-nutritional high-intensity sweeteners. In addition, some non-nutritional high-intensity sweeteners further have problems of inconvenient usage and poor thermal stability. Therefore, composite sweeteners have been developed in recent years, sweetness quality and using performance of which are improved by using synergistic interaction among different sweeteners. Meanwhile, the production cost is also reduced, so the composite sweeteners are more and more popular in the food and beverage industries, and provide important directions for development and application of the sweeteners.

The requirements for ideal sweetener are safety, health, good sweet taste, moderate sweetness, high stability, reasonable price, being low-calorie or calorie-free. However, on the market at present the common composite sweeteners can not fully meet these requirements. Besides, the existing composite sweeteners are all mixture of solid granules, which are not easy to be uniformly mixed and thus influence the quality. And there is dust problem caused in the production and use process, which is not beneficial to clean production of the enterprises and also causes inconvenience for use.

### SUMMARY OF THE INVENTION

In order to overcome the disadvantages in the existing technology, the present invention discloses a liquid composite high-intensity sweetener having sweet taste similar to sucrose, good quality, easy to use, safe and healthy, reasonable price, so as to meet actual requirement of production and consumption. And the present invention further discloses a method for preparing the above liquid composite high-intensity sweetener, thus to provide effective guarantee for the quality and edible safety of sweetener products.

One target of the present invention is realized by the following technical proposal:

The present invention claims a liquid composite high-intensity sweetener, comprising a sweet substance and a solvent, wherein the sweet substance is one or combination of a plurality of the following components: aspartame, sucralose, acesulfame and neotame; and the solvent comprises water and one or combination of a plurality of the following components: ethanol, propylene glycol, phosphoric acid, citric acid, lactic acid, acetic acid, malic acid, ascorbic acid, glucose acid, tartaric acid, acetate, lactate, citrate, phosphate, sorbic acid, sorbate, benzoic acid and benzoate.

The liquid composite high-intensity sweetener of the present invention is obtained by dissolving the sweet substance into the solvent, not only having the similar sweet taste to sucrose and several times to hundreds and thousands of times higher sweetness than sucrose, but also being mixed uniformly and having no particles remained; the product quality and the convenience in use are beneficially improved.

Further, relative to weight of the sweetener, the sweet substance is one or combination of a plurality of the following components: 0.1-3 wt % of aspartame, 0.1-30 wt % of sucralose, 0.1-30 wt % of acesulfame and 0.01-10 wt % of neotame. Preferably, relative to weight of the sweetener, the sweet substance is one or combination of a plurality of the following components: 1-3 wt % of aspartame, 10-15 wt % of sucralose, 3-10 wt % of acesulfame and 0.3-2 wt % of neotame.

Further, relative to weight of the sweetener, the solvent is one or combination of a plurality of the following components: 1-10 wt % of ethanol, 1-5 wt % of propylene glycol, 0.01-0.1 wt % of citric acid, 0.01-0.1 wt % of sodium citrate, 0.01-0.2 wt % of lactic acid, 0.01-0.3 wt % of malic acid, 0.01-0.05 wt % of ascorbic acid, 0.01-0.15 wt % of sorbic acid, 0.01-0.15 wt % of potassium sorbate, and 0.01-0.1 wt % of sodium benzoate, and balance of water.

In order to further improve the dissolubility of the sweet substance and the stability of composite solution composed of the sweet substance and the solvent, pH value of the composite solution is 4.2-7.5, preferably 4.2-6.5.

The other target of the present invention is realized by the following technical proposal:

The present invention claims a method for preparing the above liquid composite high-intensity sweetener, comprising the following steps: (1) mixing the sweet substances, and dissolving and mixing the mixture in the solvent to obtain the composite solution; (2) subjecting the composite solution to high temperature sterilization treatment at a temperature of 60-150° C. for 1-600 s; (3) after the high temperature sterilization treatment, lowering the temperature to the room temperature or 25-60° C., the time for lowering temperature is 10-600 s, thus to obtain the liquid composite high-intensity sweetener product.

Further, the composite solution in step (2) is subjected to high temperature sterilization treatment at a temperature of 90-135° C. for 3-10 s.

Further, the temperature in step (3) is lowered to room temperature or 25-30° C., the time for lowering temperature is 150-360 s, thus to obtain the liquid composite high-intensity sweetener product.

The beneficial effects of the present invention are as follows:

(1) The sweet substances adopted by the present invention are non-nutritional sweeteners, which meets requirement of healthy food. Different sweet substances are dissolved and mixed in the solvent to obtain the liquid composite sweetener, all components being uniformly mixed and having no particles remained; the product stability is good, and synergistic interaction of all components are effectively improved, so the taste is closer to sucrose, so as to well meet the requirement of consumers on the sweet taste quality and further replace sucrose completely in actual use, as well as reduce production cost of using sucrose.

(2) The present invention effectively solves the problem that the solid granular sweet substances cannot be mixed uniformly, and also avoids the dust problem in producing and using the existing solid sweeteners, which is beneficial to improve cleanness of production environment and using process, and improves the convenience in use.

(3) During preparation process of the liquid composite sweetener of the present invention, the high temperature sterilization treatment is used instead of adding preservatives, which effectively solves problems of changing color, hydrolysis and corrosion, and more beneficial for edible safety of the product.

(4) The preparation method of the present invention is simple and effective, being easy to be controlled and suitable for large-scale promotion and application.

The following is detailed description of the present invention in combination with embodiments.

### DETAILED DESCRIPTION OF THE PREFERRED EMBODIMENTS

### Embodiment 1

1. Components of the liquid composite high-intensity sweetener of the present invention are as follows: 10 wt % of sucralose, 0.3 wt % of neotame, 5 wt % of acesulfame, 0.1 wt % of citric acid, and balance of water.

2. Preparation method of the liquid composite high-intensity sweetener of the present invention is as follows: (1) mixing sucralose, neotame and acesulfame, and dissolving and mixing the mixture in the solvent prepared with citric acid and water to obtain the composite solution, the pH value of the composite solution being 4.2; (2) subjecting the composite solution to high temperature sterilization treatment at a temperature of 100° C. for 10 s; (3) after the high temperature sterilization treatment, lowering the temperature to 25° C., the time for lowering temperature is 300 s, thus to obtain the liquid composite high-intensity sweetener product.

### Embodiment 2

1. Components of the liquid composite high-intensity sweetener of the present invention are as follows: 1 wt % of neotame, 10 wt % of acesulfame, 2 wt % of propylene glycol, 0.05 wt % of sorbic acid, 0.05 wt % of potassium sorbate, and balance of water.

2. Preparation method of the liquid composite high-intensity sweetener of the present invention is as follows: (1) mixing neotame and acesulfame, and dissolving and mixing the mixture in the solvent prepared with propylene glycol, sorbic acid, potassium sorbate and water to obtain the composite solution, the pH value of the composite solution being 4.7; (2) subjecting the composite solution to high temperature sterilization treatment at a temperature of 130° C. for 5 s; (3) after the high temperature sterilization treatment, lowering the temperature to 25° C., the time for lowering temperature is 250 s, thus to obtain the liquid composite high-intensity sweetener product.

### Embodiment 3

1. Components of the liquid composite high-intensity sweetener of the present invention are as follows: 15 wt % of sucralose, 8 wt % of acesulfame, 0.03 wt % of lactic acid, 0.1 wt % of sodium benzoate and balance of water.

2. Preparation method of the liquid composite high-intensity sweetener of the present invention is as follows: (1) mixing sucralose and acesulfame, and dissolving and mixing the mixture in the solvent prepared with lactic acid, sodium benzoate and water to obtain the composite solution, the pH value of the composite solution being 5.5; (2) subjecting the composite solution to high temperature sterilization treatment at a temperature of 120° C. for 10 s; (3) after the high temperature sterilization treatment, lowering the temperature to room temperature, the time for lowering temperature is 360 s, thus to obtain the liquid composite high-intensity sweetener product.

### Embodiment 4

1. Components of the liquid composite high-intensity sweetener of the present invention are as follows: 10 wt % of sucralose, 0.5 wt % of neotame, 0.05 wt % of ascorbic acid, 0.05 wt % of potassium sorbate, and balance of water.

2. Preparation method of the liquid composite high-intensity sweetener of the present invention is as follows: (1) mixing sucralose and neotame, and dissolving and mixing the mixture in the solvent prepared with ascorbic acid, potassium sorbate and water to obtain the composite solution, the pH value of the composite solution being 5.0; (2) subjecting the composite solution to high temperature sterilization treatment at a temperature of 110° C. for 8 s; (3) after the high temperature sterilization treatment, lowering the temperature to 30° C., the time for lowering temperature is 150 s, thus to obtain the liquid composite high-intensity sweetener product.

### Embodiment 5

1. Components of the liquid composite high-intensity sweetener of the present invention are as follows: 1 wt % of aspartame, 0.3 wt % of neotame, 5 wt % of acesulfame, 7.5 wt % of sucralose, 0.03 wt % of malic acid, and balance of water.

2. Preparation method of the liquid composite high-intensity sweetener of the present invention is as follows: (1) mixing aspartame, neotame, acesulfame and sucralose, and dissolving and mixing the mixture in the solvent prepared with malic acid and water to obtain the composite solution, the pH value of the composite solution being 6.0; (2) subjecting the composite solution to high temperature sterilization treatment at a temperature of 135° C. for 3 s; (3) after the high temperature sterilization treatment, lowering the temperature to 25° C., the time for lowering temperature is 300 s, thus to obtain the liquid composite high-intensity sweetener product.

### Embodiment 6

1. Components of the liquid composite high-intensity sweetener of the present invention are as follows: 2 wt % of neotame, 3 wt % of acesulfame, 3 wt % of aspartame, 5 wt % of ethanol, 0.05 wt % of citric acid, 0.05 wt % of sodium citrate, and balance of water.

2. Preparation method of the liquid composite high-intensity sweetener of the present invention is as follows: (1) mixing neotame, acesulfame and aspartame, and dissolving and mixing the mixture in the solvent prepared with ethanol, citric acid, sodium citrate and water to obtain the composite solution, the pH value of the composite solution being 4.6; (2) subjecting the composite solution to high temperature sterilization treatment at a temperature of 90° C. for 10 s; (3) after the high temperature sterilization treatment, lowering the temperature to room temperature, the time for lowering temperature is 180 s, thus to obtain the liquid composite high-intensity sweetener product.

What is claimed is:

1. A liquid composite high-intensity sweetener, comprising a sweet substance and a solvent, wherein the sweet substance is one or combination of a plurality of the following components: aspartame, sucralose, acesulfame and neotame; and the solvent comprises water and one or combination of a plurality of the following components: ethanol, propylene glycol, phosphoric acid, citric acid, lactic acid, acetic acid, malic acid, ascorbic acid, glucose acid, tartaric acid, acetate, lactate, citrate, phosphate, sorbic acid, sorbate, benzoic acid and benzoate.

2. The liquid composite high-intensity sweetener according to claim 1, wherein the sweet substance, relative to weight of the sweetener, is one or combination of a plurality of the following components: 0.1-3 wt % of aspartame, 0.1-30 wt % of sucralose, 0.1-30 wt % of acesulfame and 0.01-10 wt % of neotame.

3. The liquid composite high-intensity sweetener according to claim 2, wherein the sweet substance, relative to weight of the sweetener, is one or combination of a plurality of the following components: 1-3 wt % of aspartame, 10-15 wt % of sucralose, 3-10 wt % of acesulfame and 0.3-2 wt % of neotame.

4. The liquid composite high-intensity sweetener according to claim 1, wherein the solvent, relative to weight of the sweetener, is one or combination of a plurality of the following components: 1-10 wt % of ethanol, 1-5 wt % of propylene glycol, 0.01-0.1 wt % of citric acid, 0.01-0.1 wt % of sodium citrate, 0.01-0.2 wt % of lactic acid, 0.01-0.3 wt % of malic acid, 0.01-0.05 wt % of ascorbic acid, 0.01-0.15 wt % of sorbic acid, 0.01-0.15 wt % of potassium sorbate, and 0.01-0.1 wt % of sodium benzoate, and balance of water.

5. The liquid composite high-intensity sweetener according to claim 1, wherein pH value of composite solution composed of the sweet substance and the solvent is 4.2-7.5.

6. The liquid composite high-intensity sweetener according to claim 5, wherein pH value of composite solution composed of the sweet substance and the solvent is 4.2-6.5.

7. A method for preparing the liquid composite high-intensity sweetener of claim 1, comprising the following steps: (1) mixing the sweet substances, and dissolving and mixing the mixture in the solvent to obtain the composite solution; (2) subjecting the composite solution to high temperature sterilization treatment at a temperature of 60-150° C. for 1-600 s;
(3) after the high temperature sterilization treatment, lowering the temperature to the room temperature or 25-60° C., the time for lowering temperature is 10-600 s, thus to obtain the liquid composite high-intensity sweetener product.

8. The method for preparing the liquid composite high-intensity sweetener according to claim 7, wherein the composite solution in step (2) is subjected to high temperature sterilization treatment at a temperature of 90-135° C. for 3-10 s.

9. The method for preparing the liquid composite high-intensity sweetener according to claim 7, wherein the temperature in step (3) is lowered to room temperature or 25-30° C., the time for lowering temperature is 150-360 s, thus to obtain the liquid composite high-intensity sweetener product.
